(19) United States
(12) Patent Application Publication
(10) Pub. No.: US 2010/0050183 A1
(43) Pub. Date: Feb. 25, 2010

(54) WORKFLOW DEVELOPING APPARATUS, WORKFLOW DEVELOPING METHOD, AND COMPUTER PRODUCT

(75) Inventor: Takao Ogura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/430,606

(22) Filed: Apr. 27, 2009

(30) Foreign Application Priority Data
Aug. 25, 2008 (JP) 2008-215389

(51) Int. Cl. G06F 9/46

(52) U.S. Cl. 718/106

(57) ABSTRACT

A computer-readable recording medium stores therein a workflow developing program that causes a computer to execute acquiring a workflow for a sequence of applications, each of which requires user authentication processing prior to execution and is on an application server; detecting a description position of a first application to be executed first in the workflow acquired at the acquiring; inserting one description of the user authentication processing into the workflow so that the user authentication processing is executed before the first application at the description position detected at the detecting; and storing, in a management server controlling the application servers, the workflow after insertion at the inserting.

### CROSS REFERENCE TO RELATED APPLICATIONS

This application is based upon and claims the benefit of priority of the prior Japanese Patent Application No. 2008-215389, filed on Aug. 25, 2008, the entire contents of which are incorporated herein by reference.

### FIELD

The embodiment discussed herein is related to a workflow developing apparatus, a workflow developing method, and computer product that develop a workflow for a sequence of applications.

### BACKGROUND

Conventionally, there is a technology of separating access control (authorization determination) and Web service execution, and automatically generating from the workflow for Web service execution, a workflow that incorporates access control. Such conventional technology simply incorporates access control where resources are controlled (for example, see Japanese Laid-Open Patent Application Publication No. 2007-4520).

However, the conventional technology has a problem in that when a network service is provided to a user by combining service components or when at a mid-flow service component, the results of the authorization determination (access control) indicate that authorization has not been granted, processing for execution of the service components up to that point becomes useless. The conventional technology further has a problem in that roll-back processing must be performed on the service components.

In the case of security assertion markup language (SAML) utilized recently with the aim of achieving single sign-on (SSO) for Web services between enterprises, access to an authenticating/authorizing server for determination of authorization occurs multiple times (verification of authentication assertion, attribute reading out, authorization processing, etc.). For this reason, there has been a problem in that execution of authorization determination for each service component causes a large number of accesses to the authenticating/authorizing server to occur.

### SUMMARY

According to an aspect of an embodiment, a computer-readable recording medium stores therein a workflow developing program that causes a computer to execute acquiring a workflow for a sequence of applications, each of which requires user authentication processing prior to execution and is on an application server; detecting a description position of a first application to be executed first in the workflow acquired at the acquiring; inserting one description of the user authentication processing into the workflow so that the user authentication processing is executed before the first application at the description position detected at the detecting; and storing, in a management server controlling the application servers, the workflow after insertion at the inserting.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram outlining workflow development according to the present embodiment;

FIG. 2 is a system configuration diagram of a network service system according to the present embodiment;

FIG. 3 is a block diagram of a workflow developing apparatus according to the embodiment;

FIG. 4 is a diagram of contents of a user information database (DB);

FIG. 5 is a diagram of contents of an authorization determination table;

FIG. 6 is a diagram of contents of an authorization policy table;

FIG. 7 is a diagram of an example of description of workflow on which development is based;

FIG. 8 is a diagram of an example of description of workflow after development;

FIG. 9 is a block diagram of a functional configuration of the workflow developing apparatus;

FIG. 10 is a diagram of typical transition relationships within a workflow;

FIG. 11 is a diagram of one example of workflow subject to separation;

FIG. 12 is a diagram of workflows after separation of a workflow depicted in FIG. 11;

FIG. 13 is a diagram of an example of determining an insertion position in workflows after separation;

FIG. 14 is a diagram of workflow having the description of the authorization decision processing inserted therein;

FIG. 15 is a diagram of workflow including a loop and subject to separation;

FIG. 16 is a diagram of a reduction of workflow;

FIG. 17 is a diagram of workflow WF2 having the description of the authorization decision processing inserted therein;

FIG. 18 is a flowchart of a workflow developing procedure automatically executed by the workflow developing apparatus according to the present embodiment;

FIG. 19 is a flowchart of workflow separation processing (step S1804);

FIG. 20 is another flowchart of the workflow separation processing (step S1804);

FIG. 21 is a flowchart of insertion position determination processing (step S1809);

FIG. 22 is a flowchart of authorization decision consolidation processing (step S1811);

FIG. 23 is a diagram of an assertion collection example;

FIG. 24A is a diagram of a description example of an attribute assertion request;

FIG. 24B is a diagram of a description example of an attribute assertion response;

FIG. 24C is a diagram of a description example of an authorization decision assertion request for presence;

FIG. 24D is a diagram of a description example of an authorization decision assertion request for log management;

FIG. 24E is a diagram of a description example of an authorization decision assertion response for presence;

FIG. 24F is a diagram of a description example of an authorization decision assertion response for log management;

FIG. 25 is a sequence diagram of an execution sequence of the workflow developed according to the present embodiment;

FIG. 26 is a sequence diagram of an example of failure with respect to authorization decision workflow developed according to the present embodiment; and

FIG. 27 is a sequence diagram of an example of failure with respect to conventional authorization decision workflow (section (A) of FIG. 1).

### DESCRIPTION OF EMBODIMENTS

Preferred embodiments of the present invention will be explained with reference to the accompanying drawings. In the present embodiment, description will be made taking an example of workflow for execution of a sequence of applications including presence, content delivery, and log management (also referred to as “service components” herein).

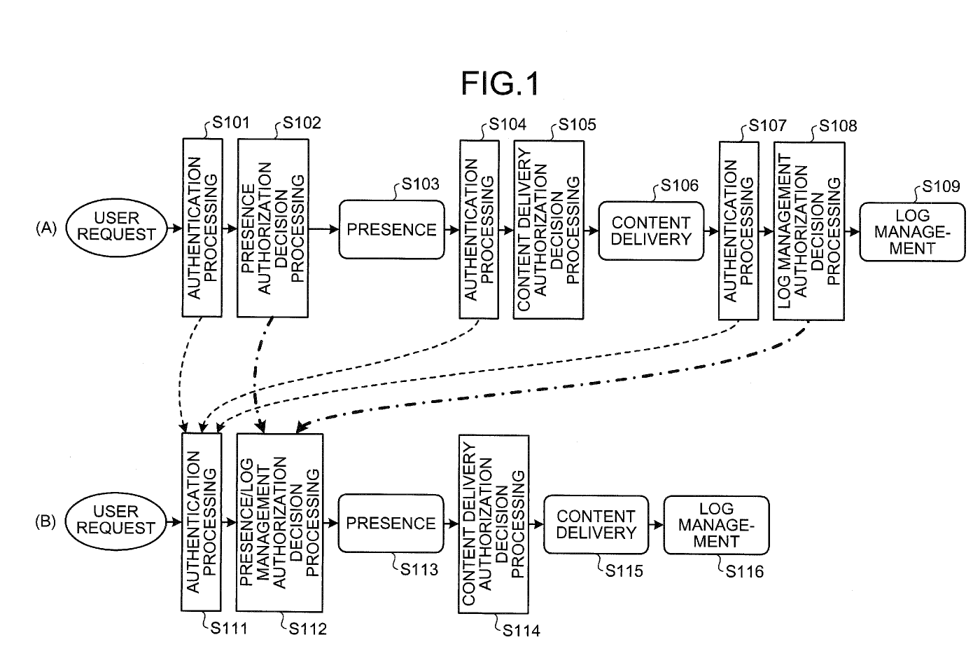

FIG. 1 is a diagram outlining workflow development according to the present embodiment. In FIG. 1, section (A) indicates conventional workflow and section (B) indicates workflow to be developed according to the present embodiment.

As depicted in section (A), upon receipt of a user request, user authentication processing for presence (step S101), authorization decision processing to determine whether execution of the presence is authorized to the user (step S102), the presence (step S103), user authentication processing for content delivery (step S104), authorization decision processing to determine whether execution of the content delivery is authorized to the user (step S105), the content delivery (step S106), user authentication processing for log management (step S107), authorization decision processing to determine whether execution of the log management is authorized to the user (step S108), and the log management (step S109) are executed. That is to say, authentication processing and authorization decision processing are performed for each application.

On the other hand, as depicted in section (B), upon receipt of the user request, user authentication processing for a sequence of applications including the presence, the content delivery, and the log management (step S111) authorization decision processing to determine whether execution of the presence and the log management is authorized to the user (step S112), the presence (step S113), authorization decision processing to determine whether execution of the content delivery is authorized to the user (step S114), the content delivery (step S115), and the log management (step S116) are executed.

That is to say, multiple executions of the authentication processing are consolidated into one execution of the authentication processing, executed before the execution of a sequence of applications. Therefore, the number of accesses to an authenticating server that executes the authentication processing is as low as one as depicted in section (B) in contrast with three as depicted in section (A). This reduction in the number of executions of the authentication processing enables a reduction in the processing load on the authenticating server.

With respect to the presence and the log management as well, after one execution of the authentication processing and before the execution of a sequence of applications, multiple executions of the authorization decision processing are consolidated into one execution of the authorization decision processing. In this example, since the content delivery is dependent on the presence, a dependency relationship between the applications takes priority over consolidation. For this reason, the authorization decision processing is executed after the presence and before the content delivery. As described with respect to section (B), the number of times authentication processing is executed is reduced to one time and the number of times the authorization decision processing is executed is reduced as much as possible and the authorization decision processing is executed before a sequence of applications.

Therefore, as depicted in section (B), according to the embodiment, the number of accesses to the authorizing server that executes the authorization decision processing is as low as two times in comparison with three times conventionally, as depicted in section (A). This reduction in the number of times that the authorization decision processing is executed enables a reduction in the processing load on the authorizing server.

A network service system authenticates the user of a client, determines whether the use of each service component is authorized to the user, and provides service to the client by the service components (applications).

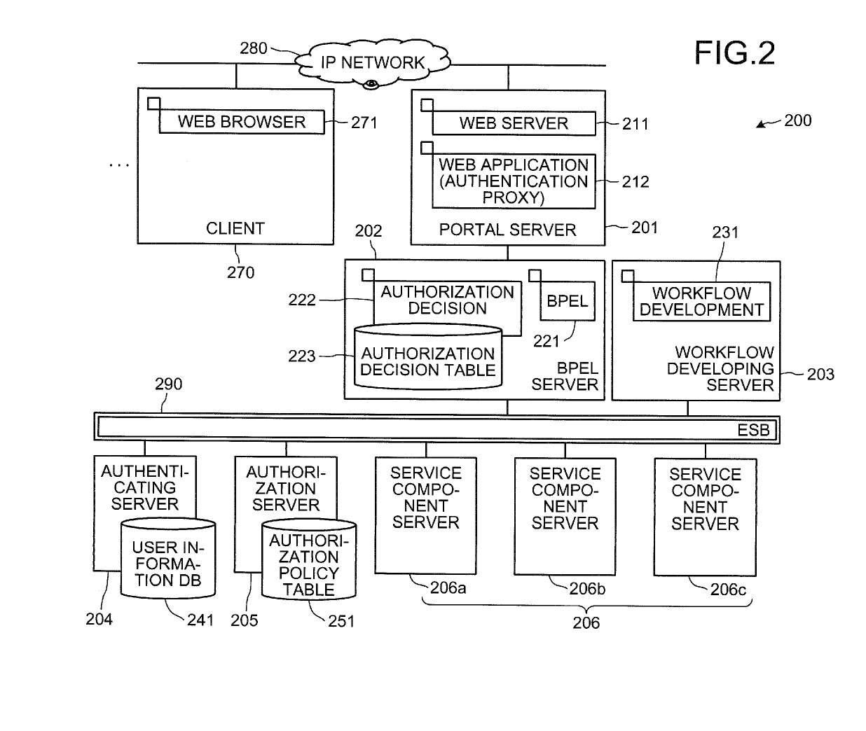

FIG. 2 is a system configuration diagram of the network service system according to the present embodiment. A network service system 200 is capable of mutually communicating with a client 270 by way of an Internet Protocol (IP) network 280. The client 270 includes a Web browser 271. The client 270 may be a console-type personal computer or may be a portable terminal such as a notebook-type personal computer, a mobile phone, and a smart phone.

The network service system 200 includes a portal server 201, a business process execution language (BPEL) server 202, a workflow developing server 203, an authenticating server 204, an authorizing server 205, and plural (three in FIG. 2) service component servers 206.

The portal server 201 is connected to the BPEL server 202. The BPEL server 202, the workflow developing server 203, the authenticating server 204, the authorizing server 205, and the service component servers 206 are connected by an enterprise service bus (ESB) 209.

The portal server 201, having a Web server function 211 and a Web application function (authentication proxy) 212, receives a request for service components from the client 270 and transmits to the client 270, a response to the request.

The BPEL server 202 has a BPEL function 221, an authorization determining function 222, and an authorization determination table 223. The BPEL function 221 is a function of controlling the service component servers 206. The authorization determining function is a function of accessing the authenticating server 204 and the authorizing server 205. The authorization determination table 223 is a table storing, for each service component, an attribute of the service component.

The workflow developing server 203 has a workflow developing function 231. The workflow developing function 231 is a function of developing a workflow for a sequence of applications (service components).

The authenticating server 204 has a user information DB 241. The user information DB stores personal information concerning the user, etc. The authenticating server 204 authenticates the user of the client 270 that accesses the network service system 200 by referring to the user information DB 241.

The authorizing server 205 has an authorization policy table 251. The authorization policy table 251 stores an attribute value for each service component attribute. The authorizing server 205 determines whether the use of the requested service component is authorized to the user authenticated by the authenticating server 204 by referring to the authorization policy table 251.

The service component servers 206 have the applications as various service components. Here, a service component server 206a is regarded as a presence server, a service component server 206b is regarded as a content delivery server, and a service component server 206c is regarded as a log management server. The presence server 206a is a server that provides a service component called “presence”. The presence is a service of providing positional information in real time.

The content delivery server 206b is a server that delivers content including video, images, music, documents, etc. The log management server 206c is a server that keeps a log of accesses made by the client 270 to the servers within the network service system 200.

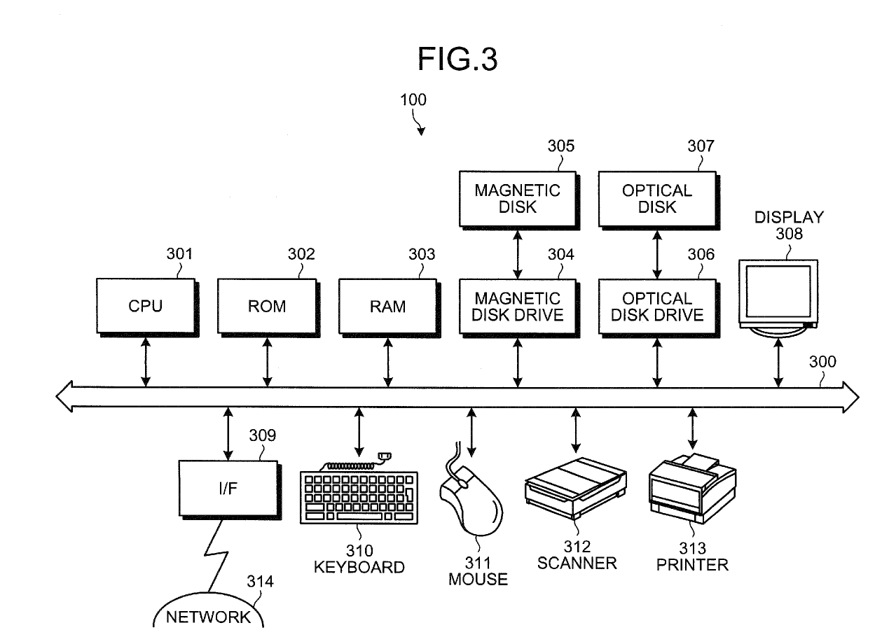

FIG. 3 is a block diagram of a workflow developing apparatus according to the embodiment. As depicted in FIG. 3, the workflow developing apparatus includes a central processing unit (CPU) 301, a read-only memory (ROM) 302, a random access memory (RAM) 303, a magnetic disk drive 304, a magnetic disk 305, an optical disk drive 306, an optical disk 307, a display 308, a interface (I/F) 309, a keyboard 310, a mouse 311, a scanner 312, and a printer 313, respectively connected by a bus 300.

The CPU 301 governs overall control of the workflow developing apparatus. The ROM 302 stores therein programs such as a boot program. The RAM 303 is used as a work area of the CPU 301. The magnetic disk drive 304, under the control of the CPU 301, controls the reading and writing of data with respect to the magnetic disk 305. The magnetic disk 305 stores therein the data written under control of the magnetic disk drive 304.

The optical disk drive 306, under the control of the CPU 301, controls the reading and writing of data with respect to the optical disk 307. The optical disk 307 stores therein the data written under control of the optical disk drive 306, the data being read by a computer.

The display 308 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 308.

The I/F 309 is connected to a network 314 such as a local area network (LAN), a wide area network (WAN), and the Internet through a communication line and is connected to other apparatuses through the network 314. The I/F 309 administers an internal interface with the network 314 and controls the input/output of data from/to external apparatuses. For example, a modem or a LAN adaptor may be employed as the I/F 309.

The keyboard 310 includes, for example, keys for inputting letters, numerals, and various instructions and performs the input of data. Alternatively, a touch-panel-type input pad or numeric keypad, etc. may be adopted. The mouse 311 is used to move the cursor, select a region, or move and change the size of windows. A track ball or a joy stick may be adopted provided each respectively has a function similar to a pointing device.

The scanner 312 optically reads an image and takes in the image data into the workflow developing apparatus. The scanner 312 may have an optical character recognition (OCR) function as well. The printer 313 prints image data and text data. The printer 313 may be, for example, a laser printer or an ink jet printer.

The data bases and tables depicted in FIG. 2 are realized by memory areas of the ROM 302, the RAM 303, the magnetic disk 305, the optical disk 307, etc.

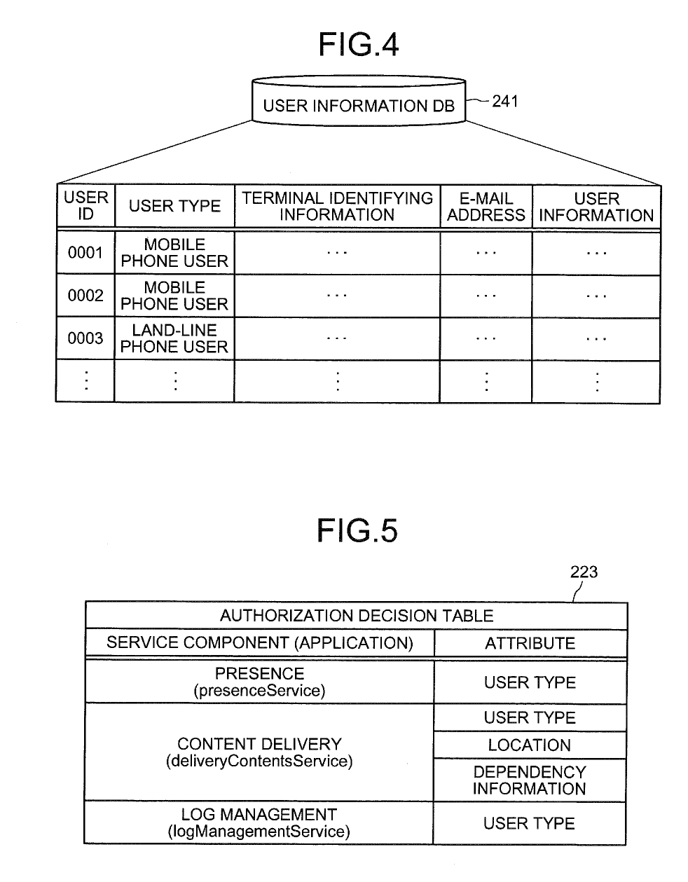

FIG. 4 is a diagram of contents of the user information DB 241. The user information DB 241 is stored in the authenticating server 204. The user information DB 241 stores a user ID, a user type, terminal identifying information, an e-mail address, and user information, for each record. The user ID is an identification number that identifies the user. The user type is information that indicates the user as a person who uses a portable terminal, or a person who uses a land-line phone, as the client 270. The terminal identifying information is a physical address of the client 270 used by the user. The e-mail address is an e-mail address by which the client 270 used by the user may transmit and receive. The user information is personal information concerning the user, such as the name and address of the user.

FIG. 5 is a diagram of contents of the authorization determination table 223. The authorization determination table 223 is stored in the BPEL server 202. The authorization determination table 223 stores a service component name and attribute type for each record. The service component name is the name of a service component. The attribute type is information indicating the kind of attribute that characterizes the service component.

For example, when the service component is the presence, the attribute type is “user type”. When the service component is the content delivery, the attribute type is “user type”, “location”, and “dependency information”. The “user type” is stored in the user information DB 241. The “location” is an area where the user (the user terminal) can receive the presence provided. The “dependency information” is information identifying the service component on which a target service component is dependent. For example, the content delivery is dependent on the presence. That is to say, authorization for the content delivery is to be determined if the presence is authorized.

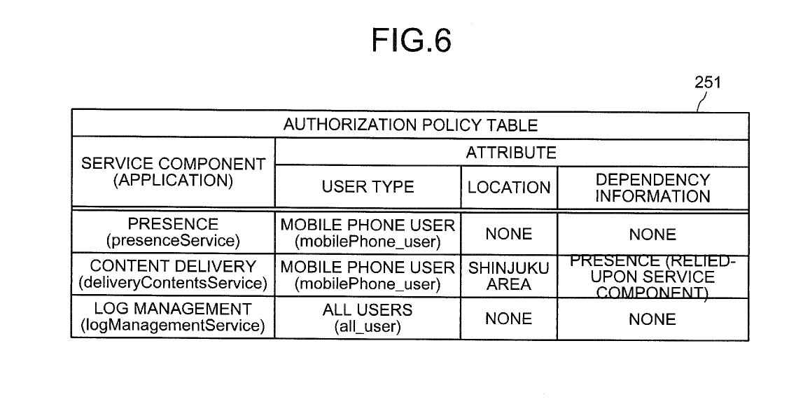

FIG. 6 is a diagram of contents of the authorization policy table 251. The authorization policy table 251 is stored in the authorizing server 205. The authorization policy table 251 stores a service component name and an attribute for each record. Concerning the attribute, details of the attribute type specified in the authorization determination table 223 are stored as the attribute.

This authorization policy table 251 indicates that execution of the presence is authorized if access is made from a mobile phone user (the user type), that execution of the content delivery is authorized if the user type is a mobile phone user in the Shinjuku area and if the execution thereof comes after the execution of the presence, and that execution of the log management is authorized if the user type is all users (irrespective of whether the user type is a mobile phone user or a land-line phone user).

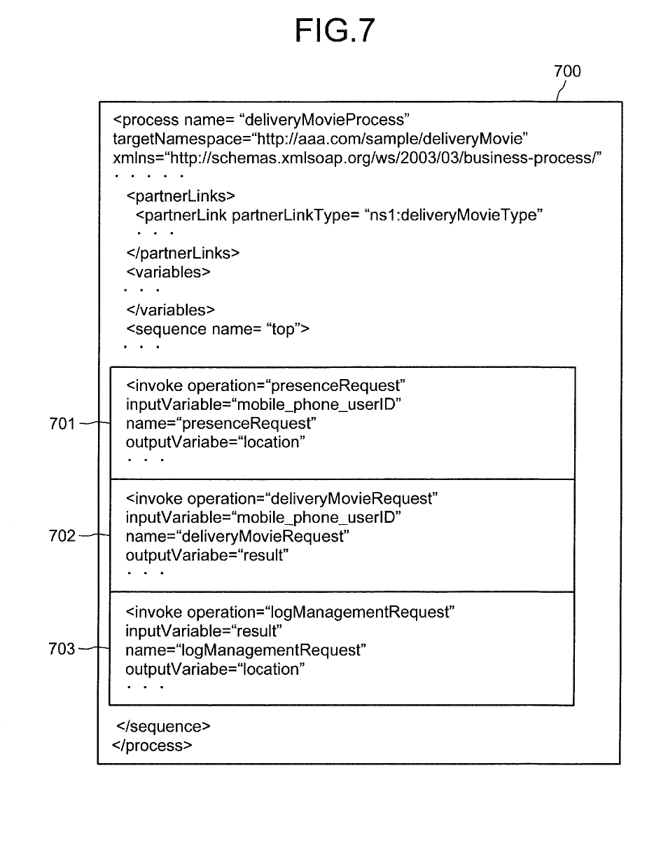

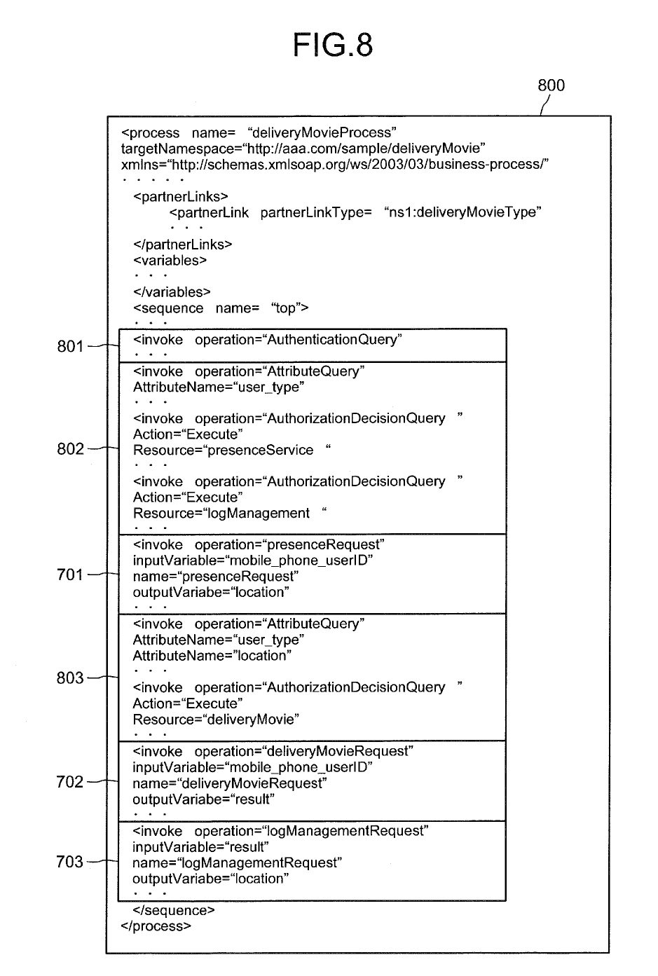

FIG. 7 is a diagram of an example of description of the workflow on which development is based. FIG. 8 is a diagram of an example of description of the workflow after development. The workflow depicted in FIG. 8 corresponds to section (B) of FIG. 1. The workflow, either a workflow 700 or a workflow 800, when given to the BPEL server 202, is read in and executed from the top line. Therefore, processing in an upper line is executed in preference to processing in a lower line.

In the workflow 700 depicted in FIG. 7, reference numeral 701 represents description of execution of the presence by the presence server 206a (hereinafter, “presence description”), reference numeral 702 represents description of execution of the content delivery by the content delivery server 206b (hereinafter, “content delivery description”), and reference numeral 703 represents description of execution of the log management by the log management server 206c (hereinafter, “log management description”).

In the workflow 800 depicted in FIG. 8, reference numeral 801 represents description of the authentication processing by the authenticating server 204 (hereinafter, “authentication processing description”), reference numeral 802 represents description of the authorization decision processing for the presence and the log management (hereinafter, “presence/log management authorization decision processing description”), and reference numeral 803 represents description of the authorization decision processing for the content delivery (hereinafter, “content delivery authorization decision processing description”). Therefore, the workflow 800 sequentially executes the authentication processing, the presence and log management authorization decision processing, the presence, the content delivery authorization decision processing, the content delivery, and the log management.

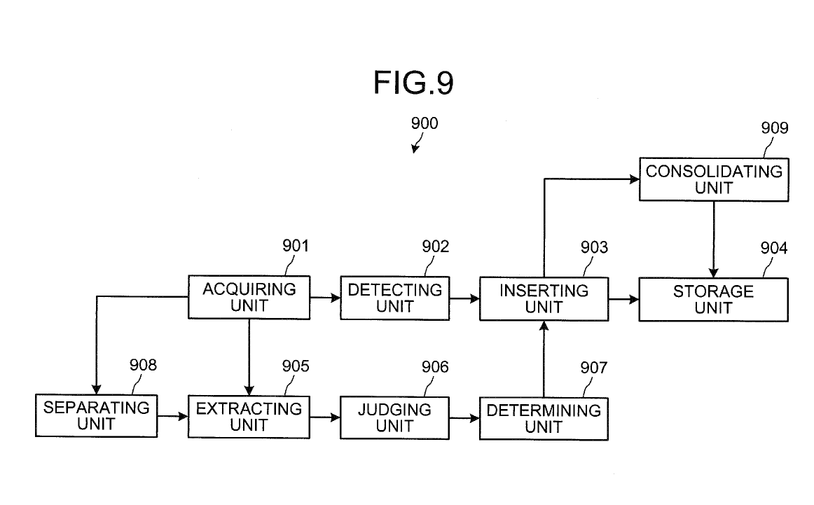

FIG. 9 is a block diagram of a functional configuration of the workflow developing apparatus. A workflow developing apparatus 900 includes an acquiring unit 901, a detecting unit 902, an inserting unit 903, a storage unit 904, an extracting unit 905, a judging unit 906, a determining unit 907, a separating unit 908, and a consolidating unit 909.

The workflow developing function 231 (the acquiring unit 901 to the consolidating unit 909), as a control unit, is implemented by causing the CPU 301 to execute a program stored in the memory area of, for example, the ROM 302, the RAM 303, the magnetic disk 305, the optical disk 307, etc., depicted in FIG. 3 or by the I/F 309. Although the workflow developing function 231 is provided in the workflow developing server 203, the workflow developing function 231 may be provided in the BPEL server 202.

The acquiring unit 901 has a function of acquiring the workflow as a flow of a sequence of applications. The workflow is specifically a sequence of applications that are in the application servers and require user authentication processing prior to execution.

The workflow may be a sequence of applications each of which requires prior to the execution, authorization decision processing that determines whether the execution is authorized to the user, in place of the authentication processing. Nonetheless, the acquiring unit 901 acquires the workflow 700 as depicted in FIG. 7. The workflow may be acquired by input through operation of a keyboard, by read out from an internal memory area, or may be received from an external computer. The acquired workflow is stored in the memory area and accessed by the CPU 301.

The detecting unit 902 has a function of detecting, in the workflow acquired by the acquiring unit 901, the position of the description (description position) of the application to be executed first. Specifically, when the CPU 301 accesses the workflow stored in the memory area and is given the workflow, the workflow is read in from the top line and thus, the detecting unit 902 detects the description to call the service component to be executed first. For instance, in the example depicted in FIG. 7, since the service component begins with the description “invoke operation= . . . ” the detecting unit 902 detects this description.

The inserting unit 903 has a function of inserting, at a position that is executed prior to the description position detected by the detecting unit 902, one description of the user authentication processing for a sequence of applications. Specifically, for example, the CPU 301 accesses the workflow stored in the memory area and the inserting unit 903 inserts the description of the authentication processing between the description line detected by the detecting unit 902 and the line preceding the detected line.

In the example depicted in FIG. 8, the inserting unit 903 inserts the authentication processing description 801 immediately upstream from the presence description. This authentication processing description 801 is a consolidation of the user authentication processing descriptions for the service components into one description. Therefore, by inserting the authentication processing description 801 upstream from the service components descriptions, the authentication processing is completed by one-time processing irrespective of the number of the service components, thereby enabling greater efficiency of the authentication processing to be achieved.

When the description of the authorization decision processing is inserted, the description is to be inserted at a position such that the authorization decision processing is executed after the user authentication processing and before the application to be executed first. Specifically, the description of the authorization decision processing is to be inserted at a position (inserting position) determined by the determining unit 907 to be described later. For example, like the presence/log management authorization decision processing description 802 depicted in FIG. 8, the description is inserted between the authentication processing description 801 and the presence description 701 and like the content delivery authorization decision processing description 803, the description is inserted between the presence description 701 and the content delivery description 702.

The storage unit 904 has a function of storing, in a management server that controls multiple application servers, the workflow after the insertion by the inserting unit 903. In this example, the workflow after the insertion is the workflow depicted in FIG. 8. The management server is the BPEL server 202 that controls the application servers, namely, the service component servers 206 in the execution of the service components.

Therefore, at the storage unit 904, the CPU 301 transmits to the BPEL server 202 by the I/F 309, the workflow after the insertion, thereby enabling the workflow after the insertion to be stored in the memory area of the BPEL server 202. When a function (the acquiring unit 901 to the consolidating unit 909) as the control unit of the workflow developing apparatus 900 is provided in the BPEL server 202, the CPU 301 stores directly in the memory area of the BPEL server 202, the workflow after the insertion.

As described, insertion of the description of the authorization decision processing between the authentication processing description 801 and the description of the head service component enables authorization decision processing for all service components to be completed by one-time processing prior to the execution of the service components. Therefore, once the authorization is given by the authorization decision processing, the service components are successively executed thereafter, thereby enabling greater efficiency of processing by the workflow to be achieved.

With respect to a service component that is dependent on another service component as specified in the authorization policy table 251, the description of authorization decision processing for the service component is not inserted between the authentication processing description 801 and the description of the head service component. This point will be described later.

The extracting unit 905 has a function of extracting, from an attribute table storing application attributes according to application, the attribute of the application selected from the workflow. Specifically, the CPU 301 reads out the attribute of the selected service component from the authorization policy table 251. For example, when the target service component is the content delivery, the CPU 301 reads out “presence” and “Shinjuku area” as a name of the attribute of the target service component.

The judging unit 906 has a function of judging whether the attribute extracted by the extracting unit 905 includes information specifying the application upon which the selected application is dependent. Specifically, for example, the CPU 301 judges whether the extracted attribute includes the name of the service component upon which the selected service component is dependent. For example, when the target service component is the presence, “mobile phone user” as the name of the attribute thereof does not include the name of a service component upon which the selected application is dependent. On the other hand, when the target service component is the content delivery, “presence” and “Shinjuku area” as the name of the attribute thereof includes a service component upon which the selected application is dependent, i.e., “presence”.

The determining unit 907 has a function of determining each insertion position for the description of authorization decision processing for a sequence of applications, based on results of judgment made by the judging unit 906. The description of authorization decision processing for a sequence of service components is inserted respectively at the insertion position(s) thus determined.

Specifically, when the judging unit 906 judges that the extracted attribute is not information specifying an application upon which the selected application is dependent, the CPU 301 determines the insertion position of the description of the authorization decision processing for the selected application so that the authorization decision processing is executed after the user authentication processing and before the application to be executed first. For example, when the target service component is the presence, “mobile phone user” (the name of the attribute thereof) does not include the name of a service component upon which the selected application is dependent. Therefore, the insertion position of the description of authorization decision processing for the presence is determined to be between the authentication processing description 801 and the presence description 701.

On the other hand, when the judging unit 906 judges that the extracted attribute is information specifying an application upon which the selected application is dependent, the CPU 301 determines the insertion position of the description of authorization decision processing for the selected application so that the authorization decision processing is executed after the application upon which the selected application is dependent and before the selected application.

For example, when the target service component is the content delivery, “presence” and “Shinjuku area” (the name of the attribute thereof) includes a service component upon which the content delivery is dependent, “presence”. Therefore, the insertion position of the description of authorization decision processing for the content delivery is determined to be at a position such that the authorization decision processing is executed after the presence description 701 and before the content delivery description 702, namely, between the presence description 701 and the content delivery description 702.

The separating unit 908 has a function of separating the workflow acquired by the acquiring unit 901 into plural workflows, based on transition relationships between successive applications in the workflow. Although the workflow upon which development is based, as depicted in FIG. 7, is a simple sequential example, actual workflow includes, in addition to the sequential relationship, various transition relationships and represents complicated paths.

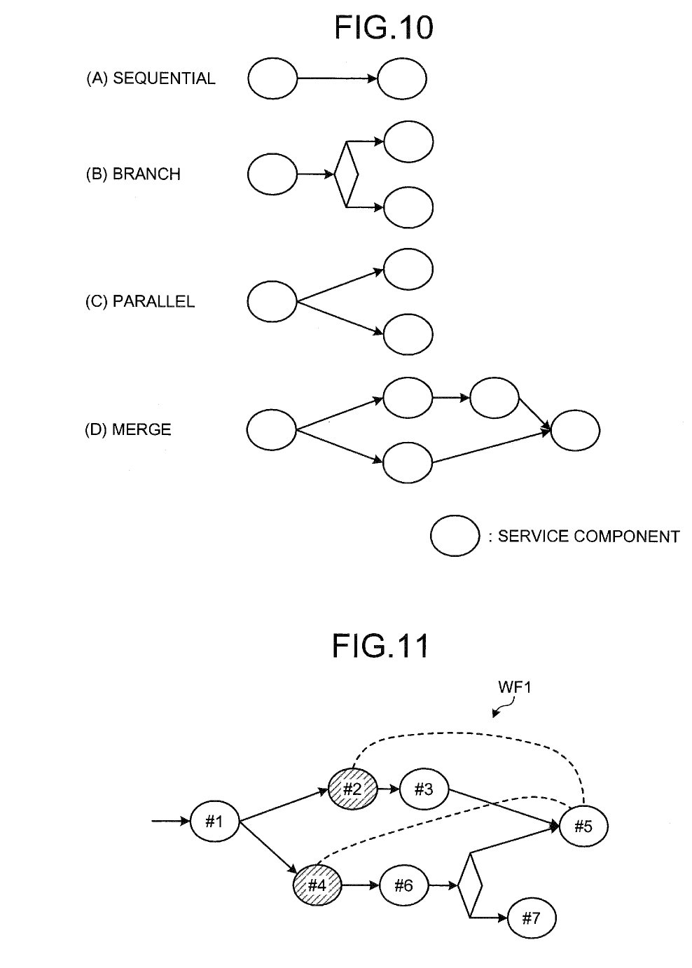

FIG. 10 is a diagram of typical transition relationships within a workflow. In FIG. 10, ovals respectively represent service components and (A), (B), (C), and (D) represent a sequential, a branching, a parallel, and a merging transition relationship, respectively. In the branching transition relationship (B), any one of the service components serving as a destination of the transition is executed and in the parallel transition relationship (C), all service components serving as a destination of the transition are executed. In the merging transition relationship (D), when all accesses are received from service components serving as merge origins, an end service component serving as a merge destination is executed.

With respect to the sequential transition relationship, there is no description between successive service components. With respect to the branching transition relationship, description indicating the branch is imbedded in description of the service component serving as the origin of the branch. By detecting the description indicating the branch, the corresponding service component becomes the origin of the branch and the service component whose name is included in the description indicating the branch becomes a destination of branch. The parallel transition relationship is similar to that of the branching transition relationship. With respect to the merging transition relationship, at the head of description of the service component, the name of the service component serving as the origin of the merge is described. At the separating unit 908, the CPU 301 executes separation processing by detecting these descriptions.

FIG. 11 is a diagram of one example of workflow subject to separation. In FIG. 11, ovals respectively represent service components, and within the ovals a service component number is indicated. A hatched oval indicates a service component upon which another service component is dependent (dependent service component) and an oval connected by a dotted line to a hatched oval is a dependent service component. For example, the service component #2 and the service component #4 are service components upon which the service component #5 is dependent. The workflow WF1 includes a sequential transition relationship (#2→#3, etc.), a parallel transition relationship (#1→#2, #4), a branching transition relationship (#6→#5,#7) and a merging transition relationship (#3,#6→#5). The workflow WF1 includes three workflows.

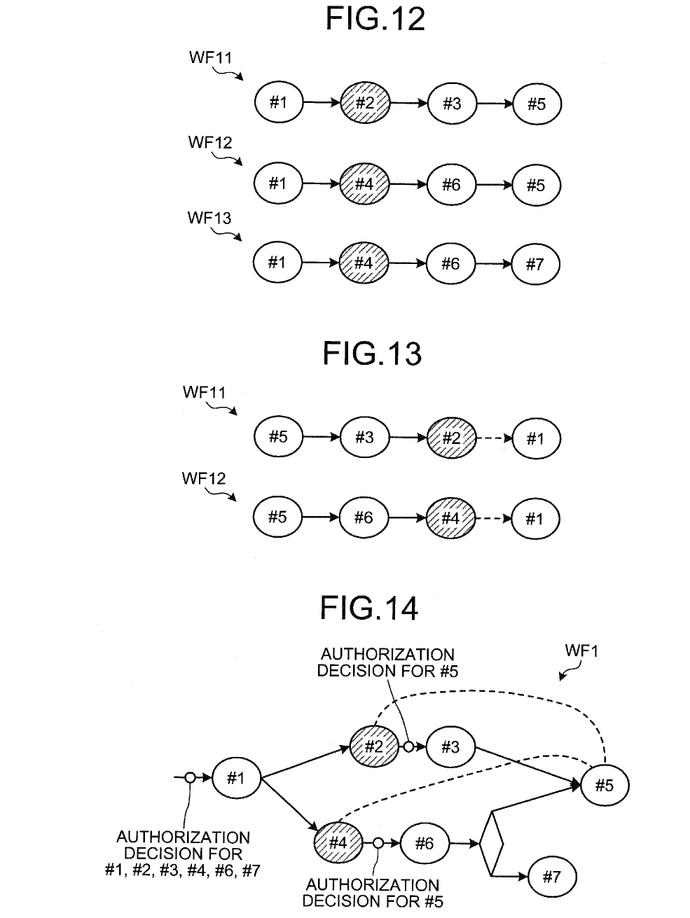

FIG. 12 is a diagram of workflows after separation of the workflow WF1 depicted in FIG. 11. All workflows WF11 to FW13 after the separation are sequential workflows. That is to say, the separation is processing involving extraction of sequential workflows from a head service component to an end service component from the workflow WF1 subject to separation.

FIG. 13 is a diagram of an example of determining the insertion position in the workflows WF11 to FW13 after the separation. The insertion position of the description of the authorization decision processing is determined by searching from an end service component to a superior service component. For example, in the workflow WF11, search is made from #5 and when #2 (the service component upon which #5 is dependent) is detected, the position between #2 and #3 is determined as the insertion position. In the workflow WF12 after the separation, search is made from #5 and when #4 (the service component upon which #5 is dependent) is detected, the position between #4 and #6, is determined as the insertion position.

FIG. 14 is a diagram of the workflow WF1 having the description of the authorization decision processing inserted therein. A small circle represents the description of the authorization decision processing. The insertion position of the description of the authorization decision processing for the service components other than #5, namely, #1 to #4, #6, and #7 is determined to be between the authentication processing description #801 (not depicted) and the description of the head service component #1. As described, since the authorization decision processing for #5 is executed after #2 and #4, roll-back processing at #3 and #6 can be eliminated.

When workflow subject to separation includes a loop that comes back to the same branching location, the separating unit 908 separates by extracting the applications making up the loop only for one loop. Since this kind of loop continues infinitely, separation of such a loop will result in a redundant workflow.

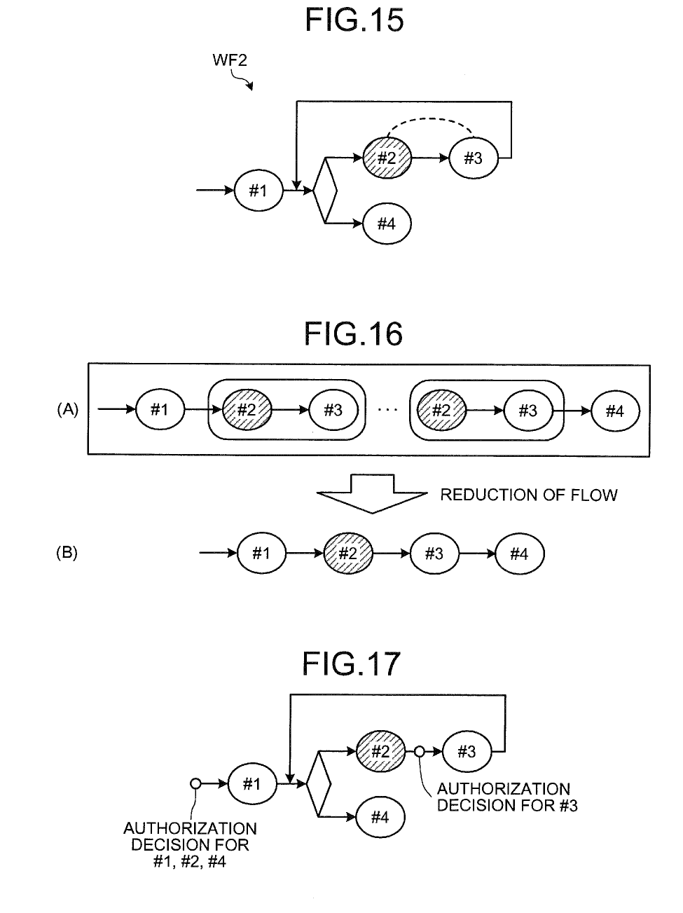

FIG. 15 is a diagram of the workflow including a loop and subject to separation. Separation of workflow WF2 will obtain, in addition to a workflow passing through #1-#4, a workflow passing through “#1→#2→#3→#2→#3→ . . . ”. The latter workflow becomes redundant and therefore, in the present embodiment, when the flow passes through the loop once and returns to a branch, a service component not in the loop is selected as a destination of branch.

FIG. 16 is a diagram of a reduction of the workflow. In FIG. 16, section (A) represents a redundant workflow before the reduction and section (B) represents the workflow after the reduction. When the flow enters a loop of “#2→#3” and comes back to the branch, the flow selects #4 instead of selecting #2. This enables obtaining “#1→#2→#2→#3→#4” as the flow after the reduction. By searching the workflow after the reduction depicted in section (B) of FIG. 16 back from the end #4, the service component #2 upon which the service component #3 is dependent is detected and the insertion position of the description of the authorization decision processing for the dependent service component #3 is determined to be between the #2 and #3.

FIG. 17 is a diagram of the workflow WF2 having the description of the authorization decision processing inserted therein. A small circle represents the description of the authorization decision processing. The description of the authorization decision processing for the service components #1, #2, and #4 is inserted between the authentication processing description 801 (not depicted) and the description of the head service component #1. The description of the authorization decision processing for #3 is inserted between #2 and #3.

The consolidating unit 909 depicted in FIG. 9 has a function of consolidating the descriptions of the authorization decision processing inserted by the inserting unit 903 into a single description of the authorization decision processing covering the applications. The description of the authorization decision processing is an attribute assertion request to the authenticating server 204 and an authorization decision assertion request to the authorization server 205. Although the description of the authorization decision processing is gathered according to service component, the attribute assertion is gathered by the CPU 301 according to attribute, not service component.

For example, since the attribute of both the presence and the log management is only “user type”, only “user_type” is inserted in the presence/log management authorization decision processing description 802 depicted in FIG. 8. As described, if the attributes are the same, the attributes are brought together instead of being kept separately for each service component. Since the attribute of the content delivery is “user type” and “location”, “user_type” and “location” are inserted in the content delivery authorization decision processing description 803″. If the attributes are different, these attributes are separately inserted. Thus, since the attribute assertion is gathered according to attribute instead of service component, higher efficiency of the authorization decision processing can be achieved.

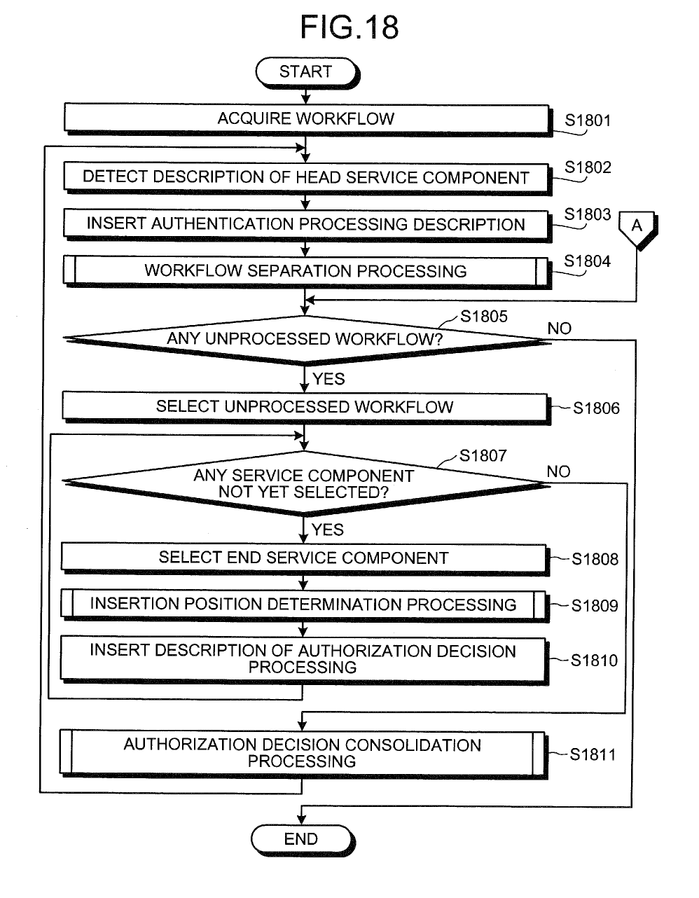

FIG. 18 is a flowchart of a workflow developing procedure automatically executed by the workflow developing apparatus 900 according to the present embodiment. As depicted in FIG. 18, the acquiring unit 901 acquires the workflow (step S1801) and the detecting unit 902 detects the description of the head service component (step S1802).

The inserting unit 903 then inserts the authentication processing description 801 (step S1803) and the separating unit 908 executes workflow separation processing (step S1804). The workflow separation processing (step S1804) will be described later. It is then judged whether there is an unprocessed workflow in the workflow after the separation (step S1805).

If there is an unprocessed workflow (step S1805: YES), the unprocessed workflow is selected (step S1806) and it is judged whether there is a service component that has yet to be selected (step S1807). If there is a service component that has yet to be selected (step S1807: YES), the end service component is selected (step S1808) and the determining unit 907 executes insertion position determination processing (step S1809). The insertion position determination processing (step S1809) will be described later.

Subsequently, the description of the authorization decision processing is inserted at the insertion position thus determined (step S1810) and the flow returns to step S1807. On the other hand, if all service components have been selected at step S1807 (step S1807: NO), the consolidating unit 909 executes authorization decision consolidation processing (step S1811). The authorization decision consolidation processing (step S1811) will be described later. The flow returns to step S1802. On the other hand, if there is no unprocessed workflow at step S1805 (step S1805: NO), a sequence of the workflow developing processing ends.

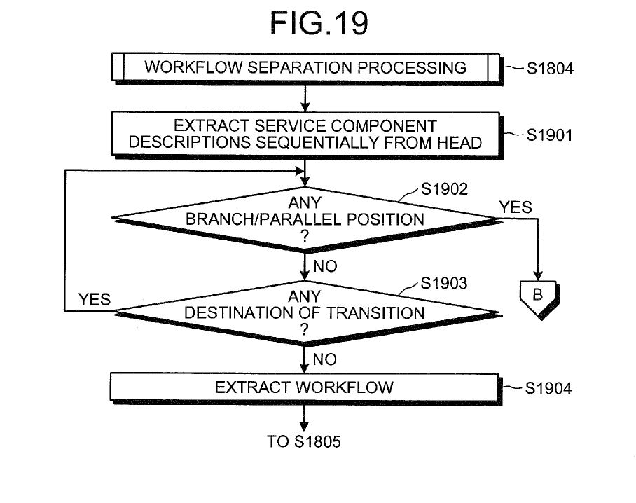

FIG. 19 is a flowchart of the workflow separation processing (step S1804). As depicted in FIG. 19, the descriptions of the service components are sequentially extracted from the head (step S1901). Taking as an example, the workflow WF1 depicted in FIG. 11, sequential extraction is made from #1. It is then judged whether there is a branch/parallel position (step S1902). If there is no branch/parallel position (step S1902: NO), it is judged whether there is a destination of transition (step S1903).

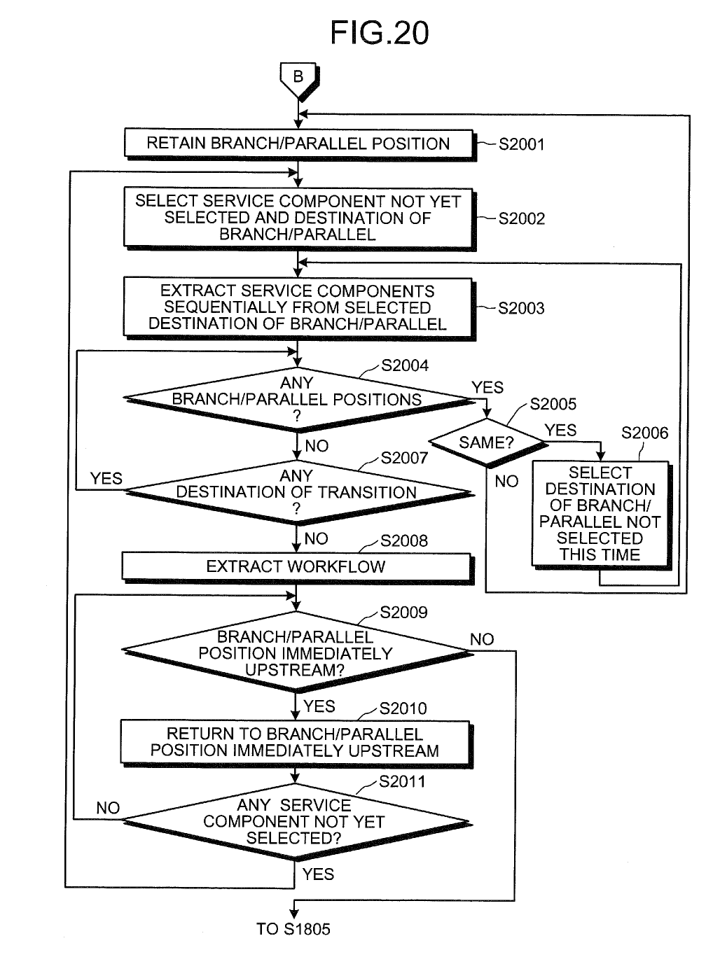

If there is a destination of transition (step S1903: YES), the flow returns to step S1902. On the other hand, if there is no destination of transition (step S1903: NO), which means that the end service component has been reached, then the workflow for a sequence of service components from the head is extracted (step S1904), and the flow proceeds to step S1805. If a branch/parallel position is detected at step S1902 (step S1902: YES), the flow proceeds to step S2001 of FIG. 20.

FIG. 20 is another flowchart of the workflow separation processing (step S1804). As depicted in FIG. 20, the branch/parallel position is stored in the memory area at step S2001 (step S2001) and the description of a service component that has yet to be selected and is a destination of branch/parallel transition is selected (step S2002). Taking as an example, the workflow WF1 depicted in FIG. 11, at #1, #1 itself is detected as a parallel position. Therefore, a parallel transition destination that has yet to be selected is selected among #2 and #4.

The descriptions of the service components are sequentially extracted from the selected destination of branch/parallel transition (step S2003). It is then judged whether there is a branch/parallel position (step S2004). If there is a branch/parallel position (step S2004: YES), it is judged whether the destination of branch/parallel transition is the same as the branch/parallel position stored at step S2001 (step 2005).

If it is judged that the destination of branch/parallel transition is the same as the branch/parallel position stored at step S2001 (step 2005: YES), which means that the service components in between make a loop, then the other destination of branch/parallel transition not selected is selected this time (step S2006) and the flow returns to step S2003. As described, if the same destination of branch/parallel is detected once, the flow transitions to the destination of branch/parallel transition not yet selected, thereby limiting the loop to one time and redundancy of the workflow can be prevented.

Taking as an example, the workflow WF2 depicted in FIG. 15, since the branch position after #1 is detected after #3, “#2→#3” is judged as a loop. Therefore, if the branch position is detected after #3, #4 that has yet to be selected is selected. On the other hand, at step S2005, if it is judged that the destination of the branch/parallel transition is not the same as the branch/parallel position stored at step S2001 (step 2005: NO), the flow returns to step S2001.

At step 2004, if there is no branch/parallel position (step S2004: NO), it is judged whether there is a destination of transition (step S2007). If there is a destination of transition (step S2007: YES), the flow returns to step S2004. On the other hand, if there is no destination of transition (step S2007: NO), which means that the end service component has been reached, then the workflow for a sequence of service components from the head is extracted (step S2008), and it is judged whether there is a branch/parallel position immediately upstream (step S2009).

If there is a branch/parallel position immediately upstream (step S2009: YES), the subject of processing returns to the branch/parallel position immediately upstream (step S2010), and it is judged whether there is description of a service component that has yet to be selected (step S2011). If there is no description of a service component that has yet to be selected (step S2011: NO), the flow returns to step S2009.

On the other hand, if there is description of a service component that has yet to be selected (step S2011: YES), the flow returns to step S2002. Consequently, a workflow of a different path can be extracted at step 2008. At step S2009, if there is no branch/parallel position immediately upstream (step S2009: NO), the flow proceeds to step S1805.

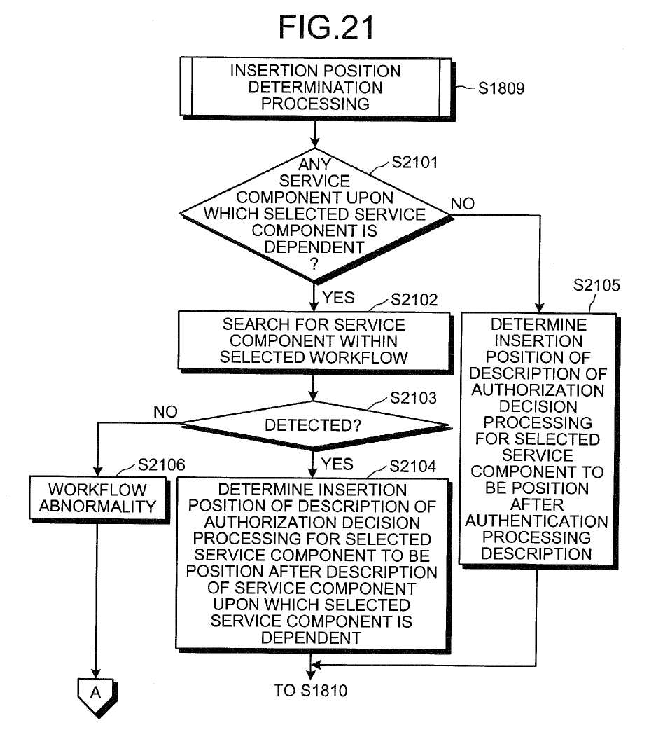

FIG. 21 is a flowchart of the insertion position determination processing (step S1809). As depicted in FIG. 21, the extracting unit 905 extracts the dependency information of the selected service component and the judging unit 906 judges whether there is a service component upon which the selected service component is dependent (step S2101). If there is no service component upon which the selected service component is dependent (step S2101: NO), the insertion position of the description of the authorization decision processing for the selected service component is determined to be the position after the authentication processing description 801 (step S2102), and the flow proceeds to step S1810.

On the other hand, if there is a service component upon which the selected service component is dependent (step S2101: YES), the service component upon which the selected service component is dependent is searched for within the selected workflow (step S2102). If the service component upon which the selected service component is dependent is not detected (step S2103: NO), such a case is determined to be a workflow abnormality (step S2106), and the flow returns to step S1805. On the other hand, if the service component is detected (step S2103: YES), the insertion position of the description of the authorization decision processing for the selected service component is determined to be the position after the description of the service component upon which the selected service component is dependent (step S2104), and the flow proceeds to step S1810.

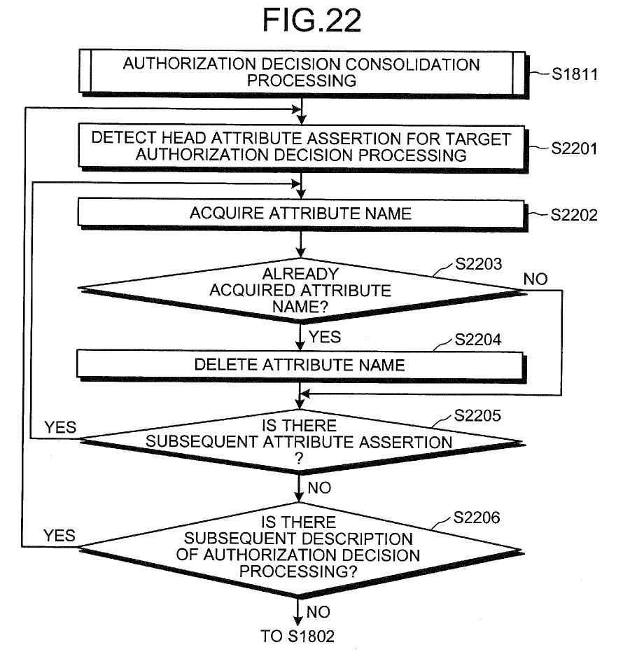

FIG. 22 is a flowchart of the authorization decision consolidation processing (step S1811). As depicted in FIG. 22, the head attribute assertion is detected for a target authorization decision processing (step S2201) and the attribute name is acquired from the detected attribute assertion (step S2202). It is judged whether the acquired attribute name is an attribute name already acquired (step S2203) and if the acquired attribute name is an attribute name already acquired (step S2203: YES), the acquired attribute name is deleted (step S2204), and the flow proceeds to step S2205.

On the other hand, if the acquired attribute name is not an attribute name already acquired (step S2203: NO), the attribute name is left as it is, and the flow proceeds to step S2205. At step S2205, it is judged whether there is a subsequent attribute assertion (step S2205). If there is a subsequent attribute assertion (step S2205: YES), the flow returns to step S2202. On the other hand, if there is no subsequent attribute assertion (step S2205: NO), then it is judged whether there is description of a subsequent authorization decision processing (step S2206).

If there is description of a subsequent authorization decision processing (step S2206: YES), the flow proceeds to step S2201. In this case, the target authorization decision processing is the subsequent authorization decision processing. In this example, the content delivery authorization decision processing description 803 after the presence/log management authorization decision processing description 802 is the description of the subsequent authorization decision processing. On the other hand, if there is no description of a subsequent authorization decision processing (step S2206: NO), the flow proceeds to step S1802.

When the workflow acquired according to the present embodiment is executed, assertion collection is performed in the description of the authorization decision processing. Here, SAML assertion collection is taken as example.

FIG. 23 is a diagram of an assertion collection example. When the BPEL server 202 transmits an authentication assertion request to the authenticating server 204, an authentication assertion response is sent back from the authenticating server 204. This exchange of the authentication assertion request and the authentication assertion response is the authentication processing. Next, when the BPEL server 202 transmits an attribute assertion request to the authenticating server 204, an attribute assertion response is sent back from the authenticating server 204. Then, when the BPEL server 202 transmits an authorization decision assertion request to the authorizing server 205, an authorization decision assertion response is sent back from the authorizing server 205.

The attribute assertion request and the attribute assertion response, and the authorization decision assertion request and the authorization decision assertion response constitute the authorization decision processing. The service component server 206, for which authorization has been determined, executes the service component that the service component server 206 is to provide.

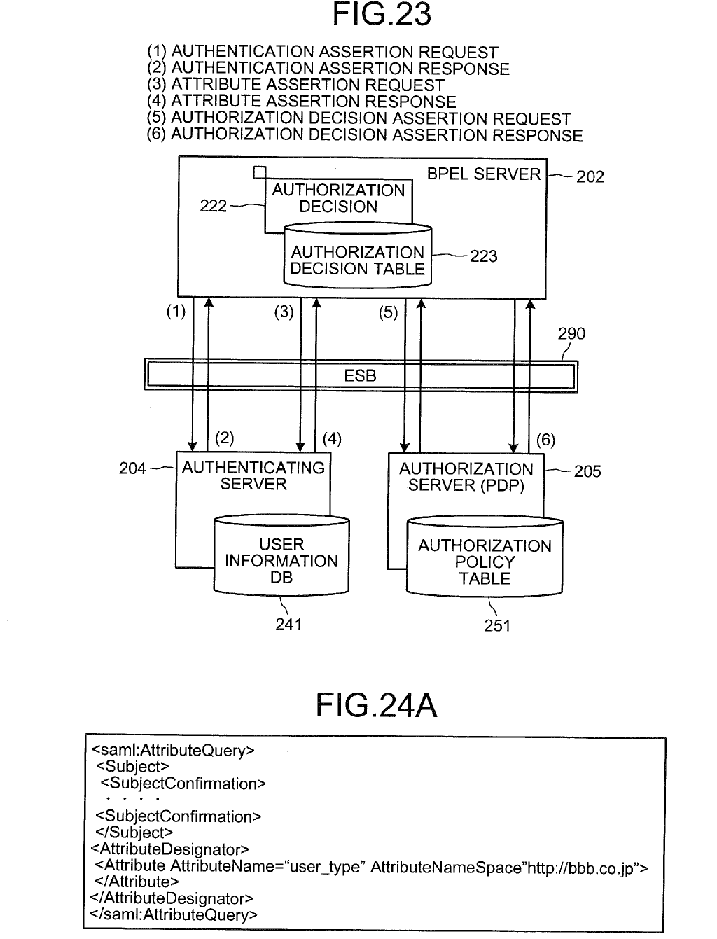

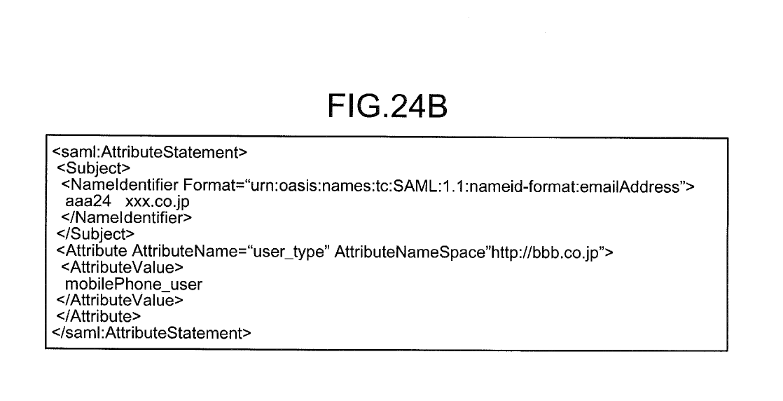

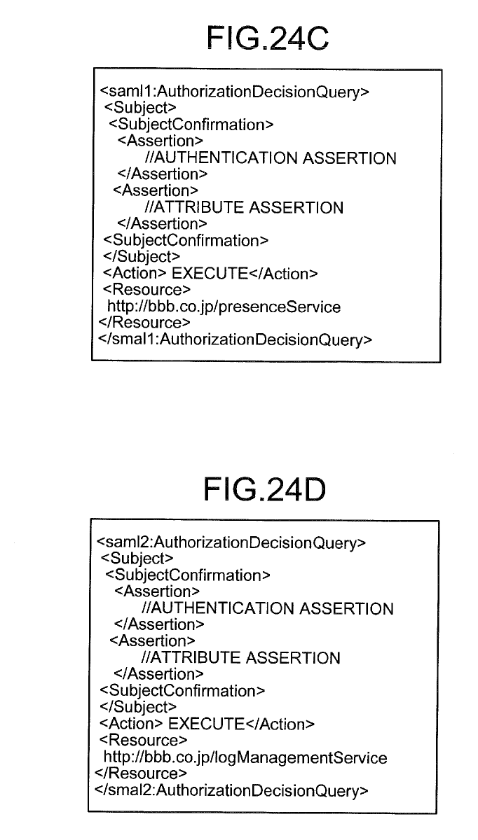

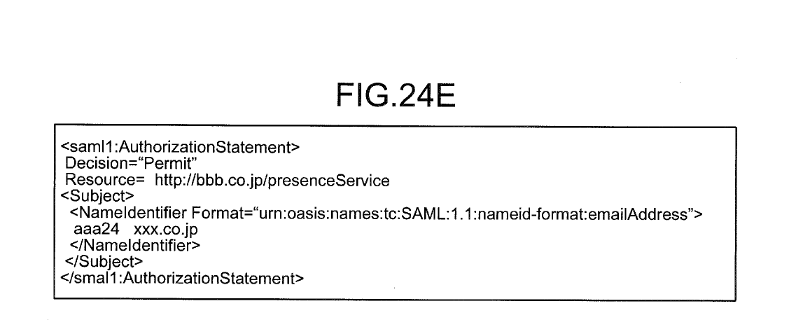

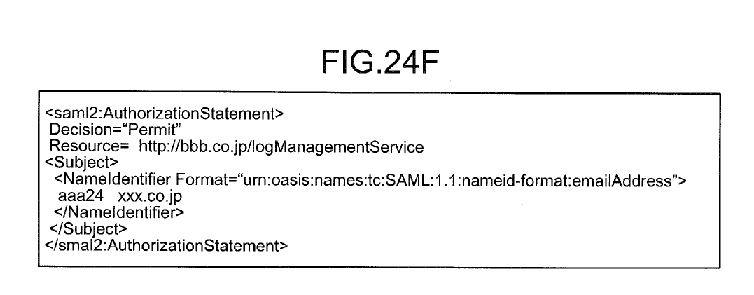

FIG. 24A is a diagram of a description example of the attribute assertion request; FIG. 24B is a diagram of a description example of the attribute assertion response; FIG. 24C is a diagram of a description example of the authorization decision assertion request for the presence; FIG. 24D is a diagram of a description example of the authorization decision assertion request for the log management; FIG. 24E is a diagram of a description example of the authorization decision assertion response for the presence; and FIG. 24F is a diagram of a description example of the authorization decision assertion response for the log management.

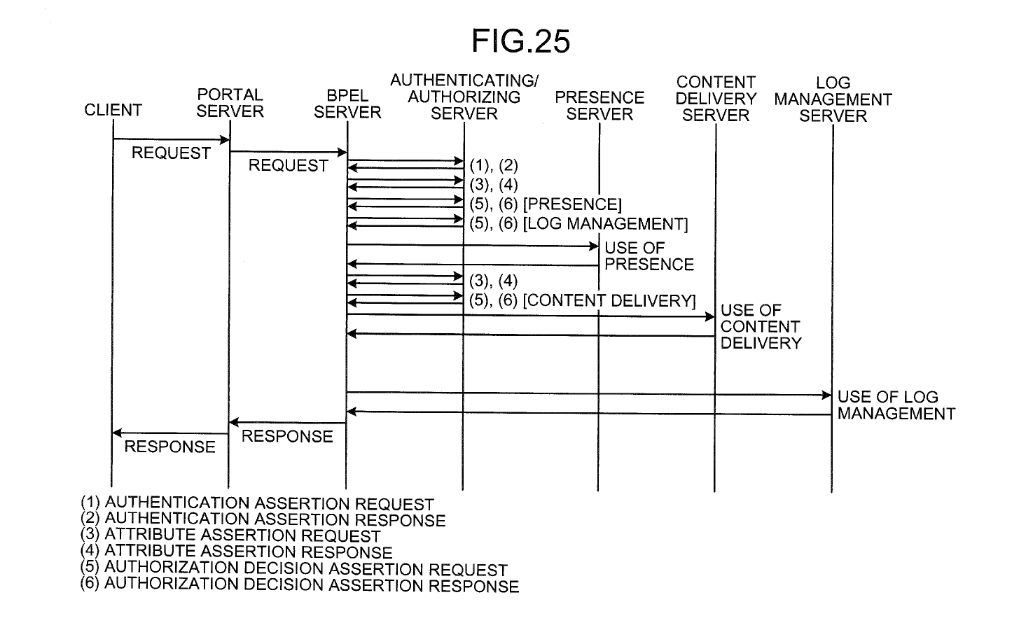

FIG. 25 is a sequence diagram of an execution sequence of the workflow developed according to the present embodiment. The execution sequence represents results of execution by reading in the workflow depicted in FIG. 8. Upon receipt of a request from the client 270, the portal server 201 transfers the request to the BPEL server 202. The BPEL server 202 executes the user authentication processing (1) and (2) with respect to the authenticating server 204 and the authorizing server 205. The BPEL server 202 then executes the authorization decision processing (3) to (6) for the presence and the log management. Thereafter, by the BPEL server 202 accessing the presence server 206a, the presence is executed.

The BPEL server 202 executes the authorization decision processing (3) to (6) for the content delivery, with respect to the authenticating server 204 and the authorizing server 205. Thereafter, by the BPEL server 204 accessing the content delivery server 206b, the content delivery is executed; and by the BPEL server 204 accessing the log management server 206c, the log management is executed. The BPEL server 202 sends a response to the request from the client 270. Specifically, the BPEL server 202 transmits, for example, the present position of the user as a result of the presence and the contents to be delivered.

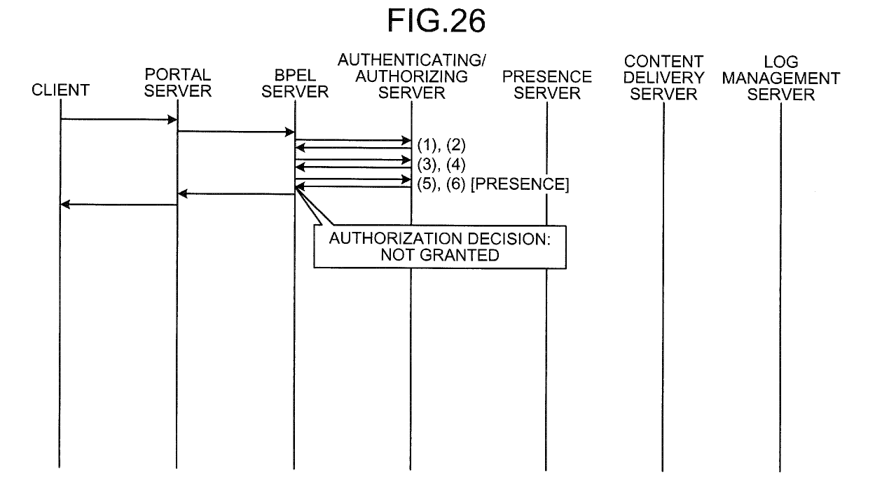

FIG. 26 is a sequence diagram of an example of failure with respect to the authorization decision workflow developed according to the present embodiment. As depicted in FIG. 26, since the authorization has not been granted for the presence, a response to that effect is sent back to the client 270. In this case, only the user authentication processing (1) and (2), the attribute assertion request (3) for the presence and the log management combined and the attribute assertion response (4), and the authorization decision assertion request (5) for the presence and the authorization decision assertion response (6) are executed. As described, since authorization for the presence is determined to be not granted at the authorization decision assertion response (6), the sequence is executed six times until becoming invalid.

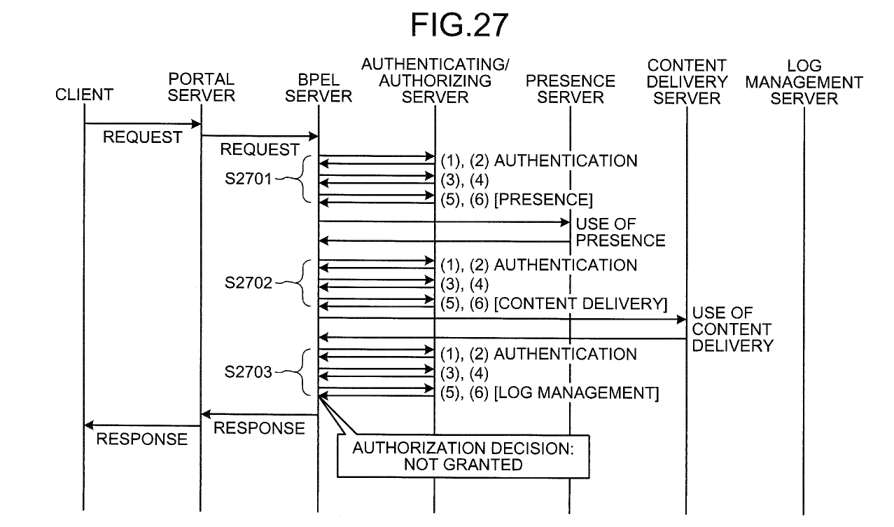

FIG. 27 is a sequence diagram of an example of failure with respect to conventional authorization decision workflow (section (A) of FIG. 1). S2701 represents the user authentication processing and the authorization decision processing for the presence in the case of providing the presence. S2702 represents the user authentication processing and the authorization decision processing for the presence in the case of providing the content delivery. S2703 represents the user authentication processing and the authorization decision processing for the presence in the case of providing the log management.

When authorization for the presence is determined to be not granted in the same manner as in FIG. 26, the sequence is executed 18 times in the conventional workflow. Therefore, the present embodiment compared with the conventional example enables 12 repetitions of the sequence to be omitted, thereby achieving higher efficiency of the network service.

As described, according to the present embodiment, when the service is provided according to the developed workflow, consolidation of authentication processing enables a reduction in the authentication processing to be achieved. Further, when the service is provided according to the developed workflow, consolidation of the authentication processing and the authorization decision processing enables a reduction in the authentication processing and the authorization decision processing to be achieved. Thus, the workflow can be executed efficiently, enabling higher efficiency of the network service to be achieved.

Since the insertion position of the description of the authorization decision processing can be determined according to the service component, the authorization decision processing can be executed as far upstream as possible while maintaining the order inherent to the service components within the workflow.

Specifically, when a service component is not dependent upon another service component, the authorization decision processing for such service component may be executed following the authentication processing, at the time of providing the service according to the developed workflow. Therefore, the authentication processing and the authorization decision processing are completed before the execution of a sequence of applications.

On the other hand, when a service component is dependent upon another service component, the dependency relationship between the service components can be given preference. Therefore, while the authentication processing and the authorization decision processing for other service components are completed before the execution of the sequence of applications, the authorization decision processing for the application corresponding to the service component having dependency is executed after the execution of the application upon which the service component is dependent. Thus, the authorization decision processing can be executed as fare upstream as possible while maintaining the order inherent to the service components within the workflow.

Therefore, restriction of the order intrinsic to the service components can be observed and the authorization decision processing can be executed efficiently. Hence, there is no need for modification of the workflow and reduction of load on a developer can be achieved.

By separating the workflow in detail and determining insertion positions with respect to each separated workflow, insertion positions of the description of the authorization decision processing can be accurately covered within the workflow subject to development.

In the case of workflow inclusive of a loop, since the workflow may be reduced, extraction of redundant workflow can be prevented and higher efficiency of workflow development can be achieved.

By consolidating the inserted descriptions of authorization determining processing to a single description of the authorization decision processing covering the applications, the authorization decision processing for the service components can be executed collectively when the service is provided according to the developed workflow. Therefore, higher efficiency of the authorization decision processing can be achieved.

As described, the present embodiment effects provision of an efficient network service by achieving reduction of load on the server. Specifically, by consolidating authorization decision processing, reduction in the number of authorization decision processing messages can be achieved and furthermore, by bringing the authorization decision processing before the service component processing as much as possible, reduction of useless executions of the service components and of roll-back processing can be achieved.

The workflow developing method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable recording medium storing therein a workflow developing program that causes a computer to execute:
acquiring a workflow for a sequence of applications, each of which requires user authentication processing and authorization decision processing that is for determining whether execution is authorized to a user prior to execution, the applications being on a plurality of application servers;
detecting a description position of a first application to be executed first in the workflow acquired at the acquiring;
inserting one description of the user authentication processing into the workflow so that the user authentication processing is executed before the first application at the description position detected at the detecting and inserting descriptions of the authorization decision processing so that the authorization decision processing is executed after the user authentication processing and before the first application; and
storing, in a management server controlling the application servers, the workflow after insertion at the inserting.

2. The computer-readable recording medium according to claim 1, wherein the workflow developing program further causes the computer to execute:
extracting, from an attribute table storing attributes according to application, an attribute of an application selected from the workflow;
judging whether the attribute extracted at the extracting includes information indicative of an application upon which the application selected is dependent; and
determining, based on a judgment resulting at the judging, an insertion position for each of the descriptions of the authorization decision processing, and
the inserting includes inserting the descriptions of the authorization decision processing at respective insertion positions determined at the determining.

3. The computer-readable recording medium according to claim 2, wherein
the determining includes determining the insertion position of a description of the authorization decision processing for the application selected so that the authorization decision processing for the application selected is performed after the user authentication processing and before the first application, when the attribute extracted at the extracting is judged at the judging to not include information indicative of an application upon which the application selected is dependent.

4. The computer-readable recording medium according to claim 2, wherein
the determining includes determining the insertion position of the description of the authorization decision processing for the application selected so that the authorization decision processing for the application selected is executed after the application upon which the application selected is dependent and before the application selected, when the attribute extracted at the extracting is judged at the judging to include information indicative of an application upon which the application selected is dependent.

5. The computer-readable recording medium according to claim 3, wherein the workflow developing program further causes the computer to execute:
separating the workflow into a plurality of sub-workflows based on a transition relationship between successive applications within the workflow,
the extracting includes extracting, from the attribute table, the attribute of an application selected from a sub-workflow, and
the judging includes judging whether the attribute extracted at the extracting includes information indicative of an application upon which the application selected from the sub-workflow is dependent.

6. The computer-readable recording medium according to claim 4, wherein the workflow developing program further causes the computer to execute:
separating the workflow into a plurality of sub-workflows based on a transition relationship between successive applications within the workflow,
the extracting includes extracting, from the attribute table, the attribute of an application selected from a sub-workflow, and
the judging includes judging whether the attribute extracted at the extracting includes information indicative of an application upon which the application selected from the sub-workflow is dependent.

7. The computer-readable recording medium according to claim 5, wherein
the separating, when the workflow includes a loop that comes back to a same branch/parallel position, includes separating by extracting applications forming the loop only for one loop.

8. The computer-readable recording medium according to claim 6, wherein
the separating, when the workflow includes a loop that comes back to a same branch/parallel position, includes separating by extracting applications forming the loop only for one loop.

9. The computer-readable recording medium according to claim 1, wherein the workflow developing program further causes the computer to execute:
consolidating descriptions of the authorization decision processing inserted by the inserting unit to a single description of the authorization decision processing covering the applications,
the storing includes storing, in the management server, the workflow after consolidation at the consolidating.

10. A workflow developing apparatus comprising:
an acquiring unit that acquires a workflow for a sequence of applications, each of which requires user authentication processing and authorization decision processing that is for determining whether execution is authorized to a user prior to execution, the applications being on a plurality of application servers;
a detecting unit that detects a description position of a first application to be executed first in the workflow acquired by the acquiring unit;
an inserting unit that inserts one description of the user authentication processing into the workflow so that the user authentication processing is executed before the first application at the description position detected by the detecting unit and inserts descriptions of the authorization decision processing so that the authorization decision processing is executed after the user authentication processing and before the first application; and
a storage unit that stores, in a management server controlling the application servers, the workflow after insertion by the inserting unit.

11. A workflow developing method comprising:
acquiring a workflow for a sequence of applications, each of which requires user authentication processing and authorization decision processing that is for determining whether execution is authorized to a user prior to execution, the applications being on a plurality of application servers;
detecting a description position of a first application to be executed first in the workflow acquired at the acquiring;
inserting one description of the user authentication processing into the workflow so that the user authentication processing is executed before the first application at the description position detected at the detecting and inserting descriptions of the authorization decision processing so that the authorization decision processing is executed after the user authentication processing and before the first application; and
storing, in a management server controlling the application servers, the workflow after insertion at the inserting.
